(19) United States
(12) Patent Application Publication
(10) Pub. No.: US 2005/0218670 A1
(43) Pub. Date: Oct. 6, 2005

(54) Striker driving assembly for a motor vehicle lock

(75) Inventors: Simon Brose, Hattingen (DE); Uwe Haarmann, Remscheid (DE)

Correspondence Address: NIXON PEABODY, LLP, 401 9TH STREET, NW, SUITE 900, WASHINGTON, DC, 20004-2128, US

(73) Assignee: Brose Schliesssysteme GmbH and Co. KG, Wuppertal (DE)

(21) Appl. No.: 11/095,591

(22) Filed: Apr. 1, 2005

(30) Foreign Application Priority Data
Apr. 3, 2004 (DE) 10 2004 016 867.9

(51) Int. Cl. E05C 3/06

(52) U.S. Cl. 292/341.16

(57) ABSTRACT

A striker driving assembly for a motor vehicle lock, with a striker carrier (2), a striker (3) and a drive mechanism (4), the striker (3) being arranged optionally detachably on the striker carrier (2), and the striker carrier (2) and with it the striker (3) can be moved from the pre-latching position into the main latching position and vice versa, the drive mechanism having a link (5), a cam (6) which engages the link (5), and a drive (7) which drives the cam (6). Displacement of the striker carrier (2) from the pre-latching position into the main latching position takes place as the cam is displaced in the link (5). To reduce the installation space, the driving mechanism (4) is arranged essentially overlapping with the path of motion of the striker (3) and the link (5) is located in the striker carrier (2).

### BACKGROUND OF THE INVENTION

1. Field of the Invention

This invention relates to a striker driving assembly for a motor vehicle lock with a striker carrier, a striker and a driving means, the striker being arranged, optionally detachably, on the striker carrier, and the striker carrier and with it the striker can be moved from a pre-latching position into a main latching position and vice versa, the driving means having a link, a cam which engages the link, and a drive which drives the cam and the displacement of the striker carrier from the pre-latching position into the main latching position taking place as the cam is displaced in the link.

2. Description of Related Art

Providing motor vehicle locks with a motorized latching aid to enhance ease of operation is known. Motorized latching aids are being used, for example, for rear hatch locks, rear door locks, also increasingly for the locks of motor vehicle side doors.

Motor vehicle locks are known in which the motorized latching aid is assigned to the latch. The striker in these motor vehicle locks is located stationary on a component of the body opposite the latch, for example, the B pillar, the C pillar or the rear frame. The striker is used as an abutment for the latch, the motorized movement of which from the pre-latching position into the main latching position pulls the vehicle door or hatch tight.

The arrangement of the motorized latching aid on the latch, and thus, on the motor vehicle door, can lead to construction problems. They can be solved by the motorized latching aid no longer being assigned to the latch, but to the striker. For this reason, there is a striker driving assembly on or in the corresponding component of the body, for example, the B pillar, the C pillar or the rear frame. This yields various advantages such as, for example, the independence of the actuating mechanism and the central locking system of the motor vehicle door from the driving means of the latching aid. A possibility of emergency opening which is necessary for safety reasons is easily implemented, since the actuating mechanism remains effective for manual actuation with respect to the latch. It is not necessary to bypass the driving means for emergency opening by construction means.

The teaching of the invention proceeds from a striker driving assembly with a striker carrier which is arranged to be able to move linearly (German Patent Application DE 100 15 596 A1). The striker can be made as a wedge-shaped striker, as a locking clip, as a locking pin, etc. If the striker is detachably mounted on the striker carrier, it can be replaced and the striker driving assembly can be used universally for any type of vehicle.

In the known striker driving assembly, the striker carrier is connected to a driving means. The striker carrier and with it the striker can be moved from a pre-latching position into the main latching position. Here, the pre-latching position is the position into which the motor vehicle lock is moved by manually latching the corresponding component, for example, a door. In the pre-latching position, the striker is already held by the latch. The corresponding component of the body is latched in this position, but the seal located on the body is not yet completely compressed. The main latching position is the final position into which the striker can be moved out of the pre-latching position. The seal in this position is compressed between the body and the corresponding component of the body, and the component is in its end position.

The driving means of the above explained striker driving assembly has a link which is made as a slot, a cam which engages the link and a drive which drives the cam. The driving means here does not act directly on the striker carrier, but is connected to a toggle lever arrangement which for its part acts on the striker carrier. The link is provided in a laterally projecting lever segment of the toggle lever arrangement. The cam which engages this link is driven by a motor in conjunction with multistage spindle gearing which sits laterally next to the toggle lever arrangement.

The disadvantage in the prior art is that part of the striker driving assembly is located laterally from the drive axle of the cam, and thus, in the direction of motion of the striker. For this reason, installation space is required at points on which there is especially little space in the body, specifically in the B pillar (relevant installation space).

### SUMMARY OF THE INVENTION

A primary object of this invention is, thus, to devise a striker driving assembly with a cam and a link in which the relevant installation space is reduced, and at the same time, an adequate reduction ratio is ensured.

This object is achieved in a striker driving assembly in which the driving means is arranged essentially overlapping with the path of motion of the striker and the link is located in the striker carrier.

The basic idea of this invention is to arrange the driving means overlapping with the path of motion of the striker. This is achieved in that the striker carrier can be driven directly by means of the cam. To do this, the link which the cam engages is in the striker carrier itself. The cam is driven by the drive so that by means of the link guide the striker carrier can be moved from the pre-latching position into the main latching position. Short paths, suitable lever arms and a simple and compact construction are the result.

It is advantageous if the driving means altogether forms a pronounced longitudinal axis and is arranged such that the longitudinal axis lies essentially transversely to the direction of motion of the striker. This allows an essentially elongated structure of the striker driving assembly so that it can be installed especially easily in a B pillar or C pillar of the body.

It is especially advantageous to shape the link such that the displacement of the striker takes place in a quasi-linear manner. For this reason, the striker carrier is especially pivotally mounted. In this way, an additional increase of the speed reduction can be achieved, so that still smaller motors with higher rated rpm can be used and thus the relevant installation space is further reduced.

Furthermore, it is advantageous to support the cam laterally in the pre-latching position and/or the main latching position in order not to overload the cam.

Another advantage arises when the drive has a toggle lever arrangement which preferably comprises three different levers. Making the levers of different length makes it possible to achieve a further speed reduction, so that an especially small motor can be used for moving the striker from the pre-latching position into the main latching position.

Other details, features, objectives and advantages of this invention are explained in detail below with reference to the accompanying drawings.

### BRIEF DESCRIPTION OF THE DRAWINGS

FIG. 1 shows the striker driving assembly in accordance with the invention,

FIG. 2 is a sectional view of the drive of the cam of the striker driving assembly from FIG. 1,

FIG. 3 shows another embodiment of the striker driving assembly, and

FIG. 4 is a perspective view of a third embodiment of a striker driving assembly.

### DETAILED DESCRIPTION OF THE INVENTION

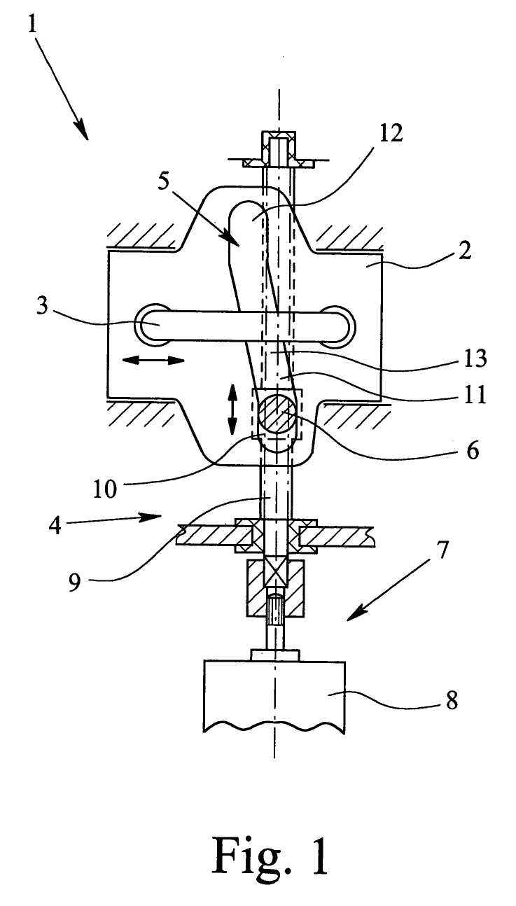

FIG. 1 shows a striker driving assembly 1 for a motor vehicle lock with a striker carrier 2, a striker 3 and a driving means 4. The striker 3 can be detachable mounted on the striker carrier 2, for example, by means of a screw. In the embodiment shown here, the striker 3 is made as locking clip. The striker 3 can also be made as a locking pin, wedge-shaped striker, etc.

The detachable connection makes it possible to replace the striker 3 and to match the striker driving assembly 1 to the requirements of the respective application in this way. The striker driving assembly 1 for this reason can be universally used.

The driving means 4 has a link 5, a cam 6 and a drive 7 which drives the cam 6. The driving means 4 forms a pronounced longitudinal axis (dot-dash line in FIGS. 1, 2, 3) and with this longitudinal axis is located essentially transversely to the direction of motion of the striker 3. The link 5 is located in the striker carrier 2. In this way, a link guide is provided, by means of which the striker carrier 2, and thus, also the striker 3 in this embodiment, can be moved linearly from the pre-latching position into the main latching position. To do this, the cam 6 engages the link 5. The driving means 4 is located essentially overlapping with the path of motion of the striker 3. This makes it possible to reduce the relevant installation space for the striker driving assembly.

The cam 6 is driven by a drive 7. Preferably here, the drive 7 is made as a spindle drive with a motor 8, a spindle 9 and a spindle nut 10. As is already known, this makes it possible to implement high speed reduction, and thus, to use a small motor 8 with high rpm. The drive 7 of the cam 6 can, however, also be made as a hydraulic or pneumatic drive. When the drive 7 is made as a spindle drive a self-locking version can be implemented especially easily. The striker driving assembly 1 is then easily held in the desired position.

The drive 7 can have gearing, preferably single-stage gearing, optionally also multi-stage gearing. Which configuration is chosen here depends on the desired reduction ratio.

Alternatively, a reversed arrangement of the cam 6 and the link 5 is possible. The cam 6 is then located on the striker carrier 2 and the link 5 is located on a component which is driven by the drive 7. The cam 6 engages the link 5, as above, so that the striker carrier 2 is driven by the interaction of the link 5 and the cam 6 by the drive 7. This changes nothing on the overlapping between the driving means 4 and the path of motion of the striker 3.

The cam 6 in FIGS. 1 & 2 is located on the spindle nut 10 so that, by the rotation of the spindle 9, the spindle nut 10, and thus the cam 6, are driven. The cam 6 executes linear displacement motion in the link 5. The striker carrier 2, and with it the striker 3, can be moved by displacement at least from the pre-latching position into the main latching position. The reversed motion can be effected, for example, also by a spring.

The link 5 is shaped such that the displacement of the striker 3 takes place essentially transversely to the longitudinal axis of the driving means 4. For this reason, the link 5 has two areas 11, 12 which are both located essentially parallel to the longitudinal axis. The two areas 11, 12 are, moreover, offset parallel to one another and are located essentially in succession. The two areas 11, 12 are additionally connected to one another by a third area 13. The third area 13 runs between the two areas 11, 12 at an angle relative to the longitudinal axis of the driving means 4. The angle here is between 5° and 80°, preferably between 10° and 40°.

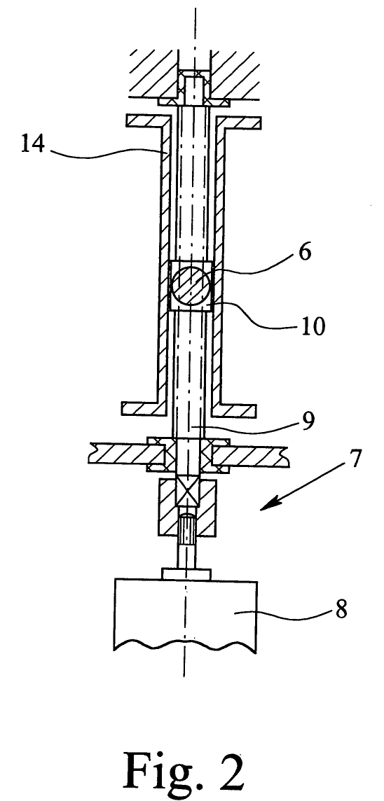

The link 5 here is preferably only so wide that it accommodates the cam 6 essentially without play. In this way optimum power transmission from the cam 6 to the striker carrier 2 is ensured. It is furthermore advantageous if there is a lateral guide 14 for the drive 7 of the cam 6, here the spindle nut 10 (FIG. 2). The lateral guide 14 can accommodate the forces transmitted by the cam 6 to the drive 7, here to the spindle 9 and the spindle nut 10, so that the drive 7 is not unnecessarily loaded.

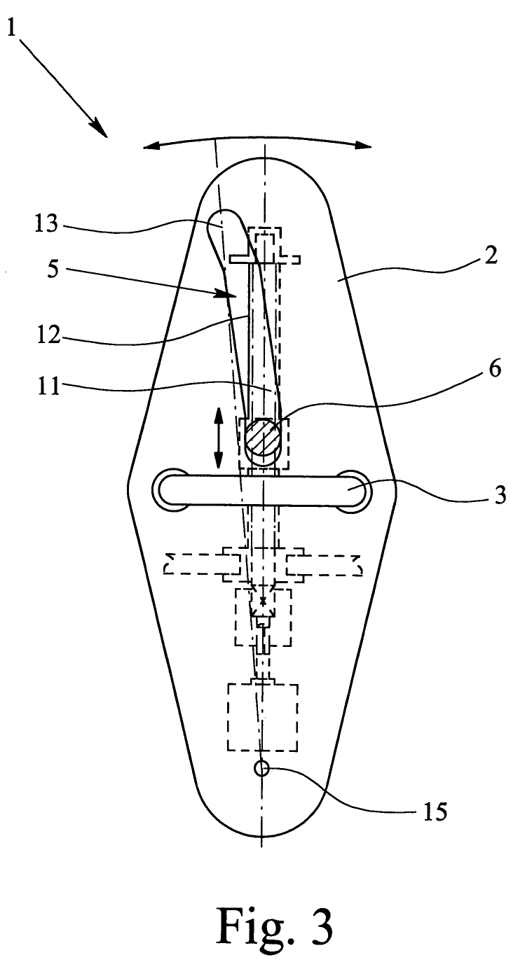

FIG. 3 shows another embodiment of a striker driving assembly 1 of the invention. In it, the striker carrier 2 is supported such that the displacement of the striker 3 takes place in a quasi-linear manner. This means that the displacement of the striker 3 does not takes place entirely linearly, but is accompanied by slight rotation or sideways motion. For this reason, the striker carrier 3 is preferably mounted here to be able to pivot around a pivot axis 15. The pivot axis 15 of the striker carrier 2 is arranged such that it intersects the longitudinal axis of the driving means 4 and the plane of the striker carrier 2 essentially vertically.

The link 5, in this embodiment, also has three areas 11, 12, 13. The first area 11 is located essentially parallel to the lengthwise axis of the driving means 4. The first area 11 is adjoined by the second area 12. The first area 11 and the second area 12 include an angle of between 135° and 175°, preferably between 150° and 170°. The second area 12 is in turn then adjoined by the third area 13. The third area 13 here is preferably bent viewed in the same direction in relative terms from the first area 11, like the second area 12. The angle between the second area 12 and the third area 13 is between 135° and 175°, preferably between 150° and 170°. The transitions between the areas need not be made angular in a narrower sense. Soft transitions with the corresponding arc guides are often more feasible.

If the striker driving assembly 1 is in its pre-latching position, the cam 6 extends into the link 5 in the area 11. Upon displacement into the main latching position, the cam 6 extends first into the link 5 in the area 12 and then in the area 13. The bent arrangement of the three areas 11, 12, 13 pivots the striker carrier 2 around the pivot axis 15 during the displacement motion. During the displacement motion, the cam 6 moves away from the pivot axis 15. This increases the generated moment around the pivot axis 15. The moment which has been produced in this way opposes the force of the seal which arises when moving from the pre-latching position into the main latching position. The action corresponds in this respect to increased speed reduction in the drive 7.

In a preferred configuration of the striker driving assembly 1, there are supporting means which laterally support the cam 6 in the pre-latching position and/or the main latching position. In this way, the forces acting in these positions on the cam 6 can be accommodated so that an overly large torque can be avoided at the bearing point between the cam 6 and the drive 7. The mechanical load on the cam 6 is reduced.

In the embodiment shown here, the drive 7 is located on the side of the striker carrier 2 on which the pivot axis 15 is located. However, an arrangement of the drive 7 elsewhere is also possible. In this way, a variation of the relevant installation space with respect to the height and length of the striker driving assembly 1 is possible.

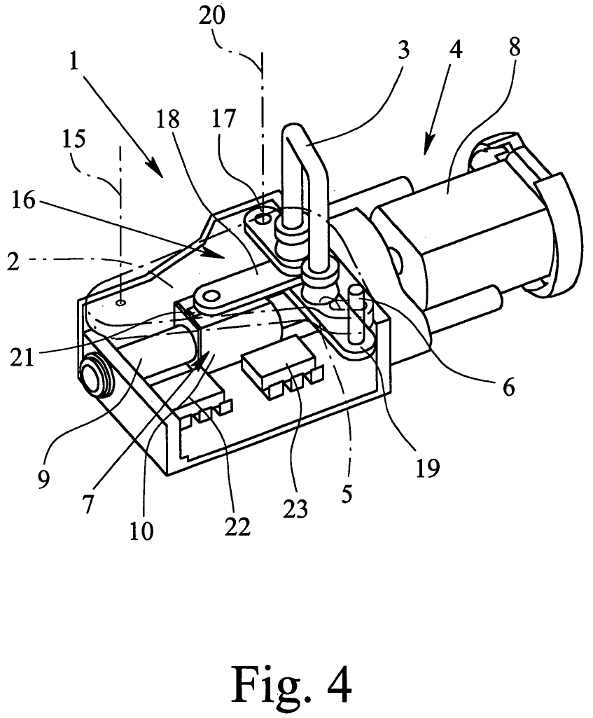

FIG. 4 shows a third embodiment of a striker driving assembly 1 in accordance with the invention. In it, the displacement of the striker 3 takes place in a quasi-linear manner. For this purpose, the striker carrier 2 (which is indicated here by only a dot-dash line) is supported to be able to pivot around a pivot axis 15. The cam 6 engages the link 5 which is provided in the striker carrier 2. By moving the cam 6, the striker carrier 2 is shifted from its pre-latching position (not shown) into its main latching position (FIG. 4) and vice versa. Therefore, a slight lateral displacement of the striker carrier 2 which is accommodated by the link 5 takes place at the same time.

The driving means 4, here, has a toggle lever arrangement 16 with three levers 17, 18, 19. All three levers 17, 18, 19 are pivotally supported relative to one another with a first end jointly on an axle which is concealed here by the overlying striker 3. (It is not connected to the striker 3). The second end of the first lever 17 is supported mounted on the housing to be able to move around an axis 20. The second end of the second lever 18 is connected to the spindle nut 10 of the spindle drive which is preferably used here. On the second end of the third lever 19 is the cam 6 which engages the link 5 of the striker carrier 2. For reasons of easier reproducibility of drawings, FIG. 4 does not show the longitudinal guide of the cam 6 in a slot located stationary on the housing, for example, mounted in a housing, the slot extending essentially transversely to the lengthwise axis of the driving means 4. The second lever 18 and the third lever 19 are made here such that they have the same length. Conversely, the first lever 17 is made shorter here. This different configuration of the levers 17, 18, 19 enables optimum use of the installation space and suitable power transmission. Of course, the levers 17, 18 19 can also be made differently with respect to their length. In particular, the shorter version of the first lever 17 relative to the third lever 19 is favorable, since the second lever 18 then becomes aligned straight during the extension of the toggle lever which is formed by the levers 17, 19.

In the displacement motion from the pre-latching position into the main latching position, the second lever 18 is driven directly by the spindle nut 10. The second lever 18 is supported and guided by the first lever 17 and drives the third lever 19. The third lever 19, in turn, moves the cam 6, and thus, the striker carrier 2 itself from the pre-latching position into the main latching position. In the main latching position, the second lever 18 is then aligned along the driving axis. If necessary, locking of the toggle lever arrangement in the main latching position is achieved by the slightly beyond dead center position.

The arrangement of the levers 17, 18, 19 makes it possible to use an especially small motor 8, since the power transmission by the levers 17, 18, 19 to the striker carrier 2 is maximum when it is located in the main latching position, and thus, also the opposing force of the door seal is maximum.

The spindle nut 10 has a buffer 21 which damps the power transmission between the spindle nut 10 and the second lever 18. In addition there are two switches 22, 23 or sensors by means of which the position of the drive 7 can be detected. In this way the drive 7 can be controlled such that it turns off when the pre-latching position or the main latching position is reached.

1. Striker driving assembly for a motor vehicle lock, comprising:
a striker carrier,
a striker and
a driving means,
wherein the striker is arranged on the striker carrier,
wherein the striker carrier, and with it the striker, is movable from a pre-latching position into a main latching position and vice versa,
wherein the driving means has a link, a cam which engages the link, and a drive which drives the cam,
wherein displacement of the striker carrier from the pre-latching position into the main latching position taking place as the cam is displaced in the link,
wherein the driving means is arranged essentially overlapping with a path of motion of the striker, and
wherein the link is located in the striker carrier.

2. Striker driving assembly as claimed in claim 1, wherein the driving means as a whole forms has a pronounced longitudinal axis and is arranged such that the longitudinal axis lies essentially transversely to the path of motion of the striker.

3. Striker driving assembly as claimed in claim 1, wherein displacement of the cam in the link is adapted to produce the displacement of the striker carrier from the pre-latching position into the main latching position.

4. Striker driving assembly as claimed in claim 1, wherein the drive of the cam comprises a spindle drive with a motor, a spindle and a spindle nut.

5. Striker driving assembly as claimed in claim 4, wherein the cam is located on the spindle nut.

6. Striker driving assembly as claimed in claim 4, wherein the spindle drive is self-locking.

7. Striker driving assembly as claimed in claim 1, wherein the drive has single-stage gearing.

8. Striker driving assembly as claimed in claim 1, wherein at least part of the drive of the cam is supported in a stationary manner on the housing.

9. Striker driving assembly as claimed in claim 1, further comprising a lateral guide for the drive of the cam.

10. Striker driving assembly as claimed in claim 1, wherein the link has a first and a second area which are both located essentially parallel to the longitudinal axis of the driving means, wherein the first and second areas are arranged offset parallel to one another, and wherein the two areas are connected to one another by a third area.

11. Striker driving assembly as claimed in claim 10, wherein the third area runs at an angle between 5° and 80° relative to the longitudinal axis of the driving means.

12. Striker driving assembly as claimed in claim 10, wherein the third area runs at an angle between 10° and 40° relative to the longitudinal axis of the driving means.

13. Striker driving assembly as claimed in claim 1, wherein the striker carrier is supported such that the displacement of the striker takes place in a quasi-linear manner.

14. Striker driving assembly as claimed in claim 13, wherein the striker carrier is pivotally mounted.

15. Striker driving assembly as claimed in claim 14, wherein the pivot axis of the striker carrier intersects the longitudinal axis of the driving means essentially perpendicularly.

16. Striker driving assembly as claimed in claim 13, wherein the link has three areas, wherein a first of the three areas is located essentially parallel to the lengthwise axis of the driving means, wherein the second of the three areas is located adjoining the first of the three areas and at an angle relative to it, and wherein the third of the three areas is located adjoining the second of the three areas and at an angle relative to it.

17. Striker driving assembly as claimed in claim 16, wherein the second of the three areas and the third of the three areas are angled in the same direction.

18. Striker driving assembly as claimed in claim 16, wherein the angle between the first of the three areas and the second of the three areas is between 135° and 175°.

19. Striker driving assembly as claimed in claim 16, wherein the angle between the second of the three areas and the third of the three areas is between 135° and 175°.

20. Striker driving assembly as claimed in claim 13, wherein the driving means comprises a toggle lever arrangement.

21. Striker driving assembly as claimed in claim 20, wherein the toggle lever arrangement has three levers, and wherein a first end of all three levers is pivotally supported relative to one another jointly on an axle.

22. Striker driving assembly as claimed in claim 21, wherein a second end of a first lever of the three levers is supported to pivot around a stationary axis on the housing.

23. Striker driving assembly as claimed in claim 21, wherein the levers form a drive train and the second lever of the three levers is located upstream of the other levers in the drive train.

24. Striker driving assembly as claimed in claim 21, wherein the cam is located on a second end of the third of the three levers, wherein the third lever of the three levers is dynamically connected to the striker carrier by means of the cam in the link.

25. Striker driving assembly as claimed in claim 24, wherein the cam is guided in a slot which is stationary on the housing and which extends transversely to the lengthwise axis of the driving means.

26. Striker driving assembly as claimed in claim 21, wherein the first lever of the three levers is shorter than the third of the three levers.

27. Striker driving assembly as claimed in claim 23, wherein the first of the three levers is shorter than the third lever.
